(19) United States
(12) Patent Application Publication
(10) Pub. No.: US 2003/0018583 A1
(43) Pub. Date: Jan. 23, 2003

(54) Method for attracting a user to a site on a computer network

(76) Inventor: John D. Ratzenberger, Calabasas, CA (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 09/910,319

(22) Filed: Jul. 20, 2001

(51) Int. Cl. G06F 17/60

(52) U.S. Cl. 705/51

(57) ABSTRACT

Methods are disclosed for attracting users to a site on a computer network owned or operated by an entity thereby enhancing the entity's ability to communicate and interact with viewers. Entertainment content and normal entity-specific content is displayed to a site viewer, such as a customer at a retail web site, upon an initial visit. The entertainment content is presumably of interest to the site viewer and provides incentive to the viewer to return to the site for a second visit. The entertainment content can be in the form of a mini-sitcom, mini-soap opera, short skits, news, animation, celebrity profiles, and the like. This content can be developed in with the entity's needs and goals in mind or can be independent of the entity and made available strictly for entertainment value. The entity can use well-known or recognizable actors to attract users to the entertainment content and, in the process, to the entity's site on a regular basis, thereby making the site “sticky.” The entertainment content is different from the entity-specific content in that the entertainment content is produced by a third party and is intended to entertain the site viewer.

### BACKGROUND OF THE INVENTION

1. Field of the Invention

The present invention relates generally to a method of attracting and increasing user traffic to sites on a network and particularly to a method that facilitates transactions and business-to-customer interactions by displaying entertainment content at the sites.

2. Discussion of Related Art

Media programming has always had a strong relationship with the marketing of goods and services. From the earliest days of radio programming, companies have sponsored programming as a marketing vehicle to build brand awareness. Advertising sponsorship money paid for the production of programming, while the programming was formatted to provide advertisers with the opportunity to promote their goods and services.

In its nascent stages, broadcast media programming consisted of half-hour or one hour episodic radio or television programs underwritten in their entirety by single sponsor companies. The sponsoring company essentially would own the broadcast time, and would run advertisements for its products at the beginning, middle and end of the program, and often there would also be a “tie in”, where the sponsor's product or name would be written into the dialogue or storyline of the program As radio and television developed, “tie ins” were eliminated and the marketing of sponsors' products was relegated to the moments between programs and during designated intervals every hour.

Throughout the history of broadcast media, programming has dominated advertising as a percentage of broadcast time. Outside the “infomercial” paid programming format, there are no commercial broadcast media where the reverse is true. Currently, one half-hour of commercial network television contains 22 minutes of programming and 8 minutes of advertising by numerous sponsors.

Today, many entities have Internet and Intranet sites where they offer information and/or sell goods and services directly to customers. For example, companies often use their web sites as low-cost alternatives to paid advertising on television and radio. Web sites can be especially useful to alert consumers to new product introductions, product availability and dealer locations, recall information, etc. However, in many industries, product cycles are such that companies' web site traffic is low except for occasional “spikes” during product introduction and roll-out periods. As a result, companies are unable to maintain consistent, low-cost communications with their customers and the ability to develop closer relationships with customers or viewers is inhibited.

Many entities therefore continue to rely on “push” marketing techniques, namely through print advertisements, billboards, banner advertisements, radio and television advertisements, direct mailings, promotional videotapes, etc., to communicate with their customer base. The sheer volume of “push” advertising in the marketplace, especially in the wake of expanded cable and satellite television opportunities and the Internet, has caused many consumers to tune out the entire panoply of messages being “pushed” at them. Nonetheless, these same consumers continue watching television, listening to the radio and going on-line for information and entertainment, which suggests that entertainment content could also be used to “pull” viewers to sites.

Furthermore, existing advertising methods require viewers to move from the advertising medium (e.g., radio or television) to the point of sale or point of further information, such as a retail store. Many print and broadcast advertisements direct consumers to a seller's web site by including a statement such as, “Visit our web site at www.seller.com”. The advertiser must rely on the consumer taking the intermediate step of going to the advertiser's web site or other point of sale for further information. As a result, businesses are forced to spend considerable amounts of money on advertising in order to persuade consumers to visit their sites.

Therefore, what is needed is a method of attracting users to an entity's online presence and develop and strengthen relationships with its viewers by displaying entertainment content on its online site. This content can take the form of a short, episodic situation comedy, for example, that airs on either an announced or unannounced schedule. In this way, an entity provides incentive for existing customers to return to its web site regularly. Likewise, potential viewers are more likely to return to the site and spend more time there, looking around, than they would if there were no entertainment component to the entity's on-line offerings. Also, since the programming is being delivered to viewers through a link from the entity's site, the risk that viewers will not take the intermediate step of going to the web site for further information is eliminated—once the entertainment content ends, the viewer will automatically be returned to the entity's online presence, where the viewer may continue to browse entity-specific content.

### SUMMARY OF THE INVENTION

Methods are described for attracting users to a site on a computer network owned or operated by an entity thereby enhancing the entity's ability to communicate and interact with viewers. The method comprises displaying to a site viewer, such as a customer at a retail web site, upon an initial visit entertainment content and normal entity-specific content. The entertainment content is presumably of interest to the site viewer and provides incentive to the viewer to return to the site for further visits. The entertainment content can be in the form of a mini-sitcom, mini-soap opera, short skit, news, animation, celebrity profiles, and the like. This content can be developed with the entity's needs and goals in mind or can be independent of the entity and made available strictly for entertainment value. The entity can use well-known personalities or independently recognizable actors to attract users to the entertainment content and, in the process, to the entity's site on a regular basis, thereby making the site “sticky.” The entertainment content is different from the entity-specific content in that the entertainment content is produced by a third party and is intended to entertain the site viewer. As mentioned, the entertainment content can be a mini-sitcom or mini-soap opera in that there is a set stable of characters and settings and follows an episodic format as seen in conventional television sitcoms. A web site can show a new episode according to a certain schedule.

### BRIEF DESCRIPTION OF THE DRAWINGS

The invention will be better understood by reference to the following description taken in conjunction with the accompanying drawings in which:

FIG. 1 is a block diagram illustrating a web page configuration utilizing the marketing method in accordance with one embodiment of the present invention.

FIG. 2 is a flow diagram of a process of a third party preparing entertainment content for an entity in accordance with one embodiment of the present invention.

### DETAILED DESCRIPTION

Reference will now be made in detail to a preferred embodiment of the invention. An example of the preferred embodiment is illustrated in the accompanying drawings. While the invention will be described in conjunction with a preferred embodiment, it will be understood that it is not intended to limit the invention to one preferred embodiment. To the contrary, it is intended to cover alternatives, modifications, and equivalents as may be included within the spirit and scope of the invention as defined by the appended claims.

A method of attracting users to a site on a computer network, such as a web site on the internet or an HTML page on an intranet, is described in the various figures. Typically, a web site operator or owner wants users to visit their site regularly. When a site is able to attract a user on a regular basis, that site is said to be “sticky”. With respect to the internet, “stickiness” has been an elusive quality for the vast majority of commercial and non-commercial web sites, regardless of whether the site is managed by a Fortune 50 company or a small business owner.

The present invention is a method of providing incentive to a user to come back to a particular site. In a specific embodiment, this incentive is used by a commercial or for-profit entity, such as AT&T®, to increase traffic to their site and presumably generate sales or enhance brand recognition and customer loyalty. In another specific embodiment, this incentive is used by a public service, educational, governmental, charity, or other not-for-profit entity, such as “Children with Diabetes.com”, to attract users to its site. In yet another specific embodiment, the incentive is used by an entity, such as a university or company, operating its own intranet to attract users (e.g., students, employees, and so on) to a particular page or site on the intranet. The method of the present invention is not tied to a particular protocol. For example, it can be implemented in a network utilizing Hypertext Transfer Protocol (HTTP) or Wireless Application Protocol (WAP), among numerous others.

In a specific embodiment, an entity site is a commercial web site on the internet that displays entity-specific information typically on numerous pages. This entity-specific information informs viewers of the goods and services provided by the entity, information about the entity, links to related sites, and so on. As described above, the content of such sites is intended to convey information to the viewer and allow the viewer to initiate a transaction. In the scenario where the viewer is visiting, for example, an online retailer the viewer can be considered a consumer or customer. In other scenarios, the viewer may simply be browsing the site for information of interest to the viewer. In many cases, information displayed at commercial, non-commercial or internal (intranet) sites is not intended to entertain a user or engage a user via dramatic or comedic content that is tangentially or peripherally related (or not related at all) to the entity-specific content.

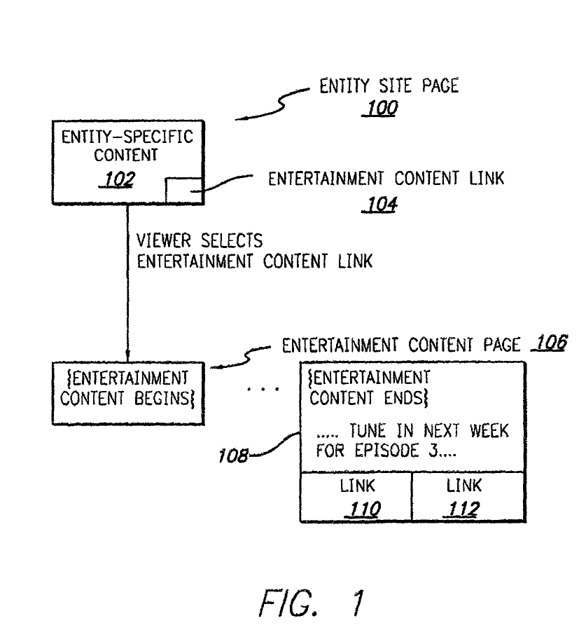

FIG. 1 is a block diagram illustrating a web page configuration utilizing the method in accordance with one embodiment of the present invention. An entity web site page 100 has two regions relevant to the present invention: a page area 102 displaying entity-specific content and a page area 104 displaying a link to entertainment content. Area 104 can be identified by a recognizable image such as that of a well-known actor or other celebrity (who plays a role in the episode). It is this feature of having a widely recognized personality on the web site that can initially pique the curiosity of a viewer and potentially draw the viewer back to the site. The viewer can enable the link and be taken to a third-party or entertainment content provider site.

Entertainment content page 106 is displayed to the viewer. The type of content can vary widely: Flash content, audio only, video only, short films, animation and numerous other types and formats. Regardless of content type, the goals are to entertain the viewer, get the entity's “message” across to the viewer and motivate the viewer to return to the site to receive the next episode. After the entertainment content has finished executing, the viewer is presented with a final display 108 where he or she is asked to “tune in” for the next episode and is given the opportunity to link to information related to the entertainment content by executing link 110. This information can be related to products or services offered by the entity or simply information on the actors/celebrities or how the entertainment content was created. The viewer can also execute a link 112 back to the entity site.

The present invention is a method of repeatedly attracting a user to a site by offering content intended to entertain the user. This content, of which there may be many different types, is the “incentive” referred to above. The purpose of the content is to entertain and engage the user to a degree whereby the user will want to come back to the site to be further entertained. In a specific embodiment, the content is provided to the user via a link to a content-provider site operated by a third-party content provider. The content-provider site can be on a separate server computer operated by the content-provider or can be stored on the same server as the entity-specific information. In any case, the user at the entity's site has the opportunity to view the content, hereinafter referred to as entertainment content to distinguish it from the entity-specific content, by “clicking” on a link indicated by a recognizable image such as that of a known actor, logo, and the like.

The entertainment content can be in one or more of numerous types and be of various lengths. In a specific embodiment, the entertainment content is episodic, where each episode is between thirty seconds to 2 minutes in length. For example, a viewer becomes familiar with a set of characters and settings or follows an ongoing story line. The collection of these comparatively short entertainment content segments comprises what can be referred to as a “mini-sitcom” or “mini-soap opera” in that each episode of the show is brief compared to the conventional 22-minute episode of a television sitcom. A new episode of the mini-sitcom or soap opera can be shown at regular intervals, such as every day or week. In another preferred embodiment, the length of each episode can be longer or shorter than this range. In yet another preferred embodiment, the entertainment content is not episodic but rather is comprised of stand-alone or independent segments unrelated to other content.

In a specific embodiment, the actual content of each segment is an episode of a show and is sufficiently entertaining or engaging to a user so that the user will want to return to the site to see the next episode. In other words, the entertainment content is episodic and shows a familiar set of characters and settings in each episode. The incentive to return to the site lies in the entertainment value of the content. Part of this value may stem initially from having an independently recognizable actor or celebrity on the web site link to attract viewers and provide entertainment. By luring a viewer back to a site, traffic on the site increases and the site operator can display to the viewer new entity-specific content and, more generally, in the case of a commercial site, is given additional opportunities to market goods and services.

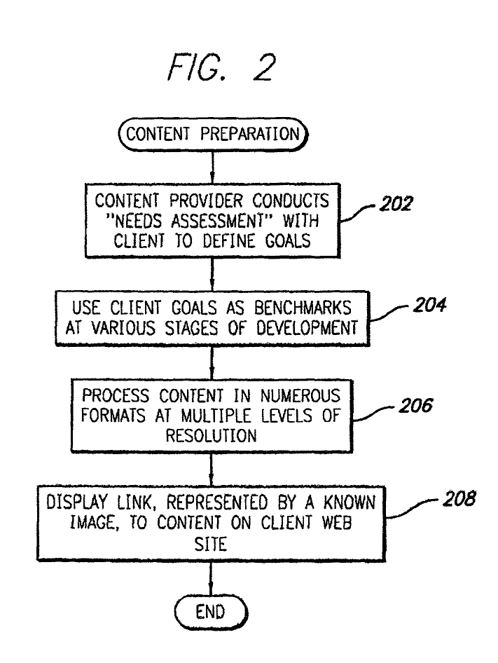

In a specific embodiment, an entity, such as a corporation (“client”) works closely with the content producers or third-party throughout the content development and production cycle. FIG. 2 is a flow diagram of a process of a third party preparing entertainment content for an entity or client. At step 202 a creative team assembled by the third party conducts a “needs assessment” with the client to define the client's business goals for the entertainment content. A client may have general or specific goals, from corporate brand-building and consumer awareness to consumer education about a specific product. The client's goals are used as benchmarks at various stages during development and production and the client may approve the project at various stages of completion as shown in step 204. In this way, the client is closely involved in the development and production of the entertainment content, leading to creation of content that best suits the client's needs while improving the web site's ability to attract customer traffic to the site.

Upon final review and acceptance by the client, at step 206 the content will be processed in multiple formats at multiple levels of resolution to accommodate a variety of internet media playback formats. The client hosts the entertainment content on its computer system (typically its web servers). Customers or viewers can access the entertainment content by clicking on a link indicated by a recognizable image, such as that of one or more actors or celebrities, and a brief description of the mini-sitcom, mini-soap opera or show at step 208. This link is updated as frequently as the entertainment content is updated.

The method of the present invention allows a web site owner to increase viewer traffic at the site by offering entertainment content developed by experienced and noted television writers and can feature celebrity talent which by its nature is more likely to draw viewers than the entity-specific content. The entertainment content can be tailored to an entity's goals and audience, facilitating the development of closer relationships between the entity and its web site viewers.

As mentioned above, in a specific embodiment, the entertainment content is short, typically less than two minutes in length. However, it is expected that because the content will resemble a TV sitcom or contain dramatic content, and not “advertising” as the term is commonly understood, the programming will “pull” customers to the site and promote return visits. Thus, the method of the present invention inverts the conventional proportion of entertainment content to advertising (where advertising is essentially the entity-specific content on the site) as seen in conventional broadcast media.

Although the foregoing invention has been described in some detail for purposes of clarity of understanding, it will be apparent that certain changes and modifications may be practiced within the scope of the appended claims. Furthermore, it should be noted that there are alternative ways of implementing both the process and apparatus of the present invention. For example, while a specific embodiment describes a link to the entertainment content, in another embodiment the entertainment content can be hosted by the entity and be contained within the entity's web site. In another example, the entertainment content may not have any connection or nexus with the entity's goods or services but rather is meant purely to entertain visitors to the web site. In yet another example, the model for increasing traffic on a site can also be used at sites in networks internal to an entity following HTTP (intranets). In addition, the entertainment content can be other types of conventional content such as short skits, news, profiles and other types of content intended to entertain and engage an audience similar to the way radio, television and cinema do so as opposed to more interactive content such as online games, such as video games, or other content requiring viewer participation. Accordingly, the present embodiments are to be considered as illustrative and not restrictive, and the invention is not to be limited to the details given herein, but may be modified within the scope and equivalents of the appended claims.

What is claimed is:

1. A method of increasing traffic at a site on a computer network for a first entity, the method comprising displaying to a site viewer upon a first visit a first content and a second content wherein the first content is of interest to the site viewer and provides incentive to the site viewer to return to the site for a second visit and wherein the first content is different from the second content in that the first content is produced by a third party and is intended to entertain the site viewer and is episodic and contains non-interactive viewer content.

2. A method as recited in claim 1 further comprising utilizing an image of an independently recognizable character to attract a site viewer to view the first content.

3. A method as recited in claim 1 further comprising developing the first content using the independently recognizable character.

4. A method as recited in claim 1 further comprising developing the first content in the form of one of a mini-sitcom and a mini-soapopera having a plurality of episodes.

5. A method as recited in claim 4 further comprising offering a new episode to the site viewer at consistent time intervals.

6. A method as recited in claim 1 wherein the first content is conventional media content.

7. A method of enhancing communication between an internet viewer and an entity having a web site and providing product information, the method comprising:
obtaining entertainment content from a third party wherein the entertainment content is related to the product information;
making the entertainment content accessible to an internet viewer on the web site; and
promoting a product associated with the product information to the internet viewer using the entertainment content wherein the entertainment content is a plurality of episodes and is intended to enhance a relationship between the internet viewer and the entity.

8. A method as recited in claim 7 further comprising utilizing an independently recognizable person in developing the entertainment content including an actor from a television show or movie.

9. A method as recited in claim 7 further comprising associating the entertainment content with the product.

10. A method as recited in claim 7 further comprising disassociating the entertainment content from the product.

11. A method as recited in claim 7 further comprising using a second episode of the entertainment content to promote a return visit by a site viewer after having viewed a first episode.
